(19) United States
(12) Patent Application Publication
(10) Pub. No.: US 2007/0297186 A1
(43) Pub. Date: Dec. 27, 2007

(54) CLAMP LIGHT

(76) Inventors: Brandon C. Hoover, Cornelius, NC (US); Matthew Shute, Charlotte, NC (US); Robin E. Smith, Stanley, NC (US)

Correspondence Address: MOORE & VAN ALLEN PLLC, P.O. BOX 13706, Research Triangle Park, NC, 27709, US

(21) Appl. No.: 11/425,844

(22) Filed: Jun. 22, 2006

(51) Int. Cl. F21V 21/08

(52) U.S. Cl. 362/396

(57) ABSTRACT

The clamp light comprises an elongated body formed of a rigid material. The elongated body supports a light source that is protected by a transparent cover. A fixed jaw is formed at one end of the elongated body and has a clamp pad formed thereon. A movable jaw having a clamp pad formed thereon is supported on the elongated body such that it can be moved along the body towards and away from the fixed jaw. The movable jaw includes ratchet teeth that engage mating ratchet teeth formed on the elongated body such that the movable jaw can be selectively locked in position relative to the body to fix the distance between the movable jaw and the fixed jaw. The clamp light can be mounted to a support structure by clamping the support structure between the clamp pads of the movable and fixed jaws.

### BACKGROUND

The invention relates generally to portable lighting and more particularly to a clamp light suitable for use on work sites and the like.

It will be appreciated that portable lighting devices are used on work sites for illuminating the work site. These lighting devices may be free standing, hand held or have an attachment mechanism such as hooks for suspending the lighting device from a support structure. While such lighting devices may be suitable for illuminating the work site, they often cannot easily and securely be mounted on the varied and irregular support structures that are available on the typical work site. Moreover, some lights do not provide adequate illumination while other lights are not of a rugged yet cost effective construction.

Thus, an improved portable light that is easily and securely mounted on a wide variety of support structures is desired.

### SUMMARY OF THE INVENTION

The clamp light of the invention comprises an elongated body formed of a rigid material such as a glass fiber polypropylene composite. The elongated body supports a light source that is protected by a transparent cover. A fixed jaw is supported at one end of the elongated body and has a clamp pad formed thereon. A movable jaw having a clamp pad formed thereon is supported on the elongated body such that it can be moved along the body towards and away from the fixed jaw to vary the distance between the jaws. The movable jaw includes ratchet teeth that engage mating ratchet teeth formed on the elongated body such that the movable jaw can be selectively locked in position relative to the body to fix the distance between the movable jaw and the fixed jaw. The light can be temporarily secured to a wide variety of support structures by clamping the support structure between the movable jaw and fixed jaw. A stand may be provided on the elongated body to allow the light to freestand vertically on a horizontal surface.

### BRIEF DESCRIPTION OF THE DRAWINGS

FIG. 1 is a side view of one embodiment of the light of the invention.

FIG. 2 is a perspective view of the embodiment of the light of the invention shown in FIG. 1.

FIG. 3 is an exploded view of the embodiment of the light of the invention shown in FIG. 1.

FIG. 4 is a top view of the embodiment of the light of the body of the light shown in FIG. 1.

FIG. 5 is an internal side view of the body of the light of the invention shown in FIG. 1.

FIG. 6 is a section view taken along line 6-6 of FIG. 1.

FIG. 7 is a partial section view taken along line 7-7 of FIG. 5.

FIG. 8 is an exploded view of the movable jaw of the embodiment of the light of the invention shown in FIG. 1.

FIG. 9 is a bottom view of a portion of the locking mechanism of the embodiment of the light of the invention shown in FIG. 1.

### DETAILED DESCRIPTION OF PREFERRED EMBODIMENTS OF THE INVENTION

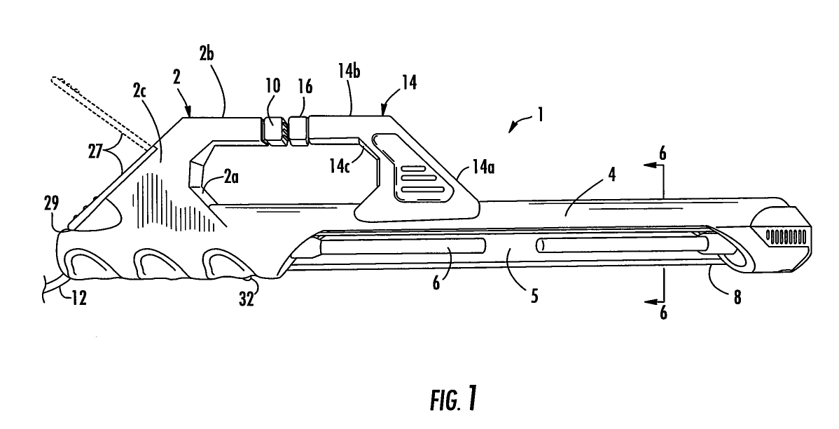

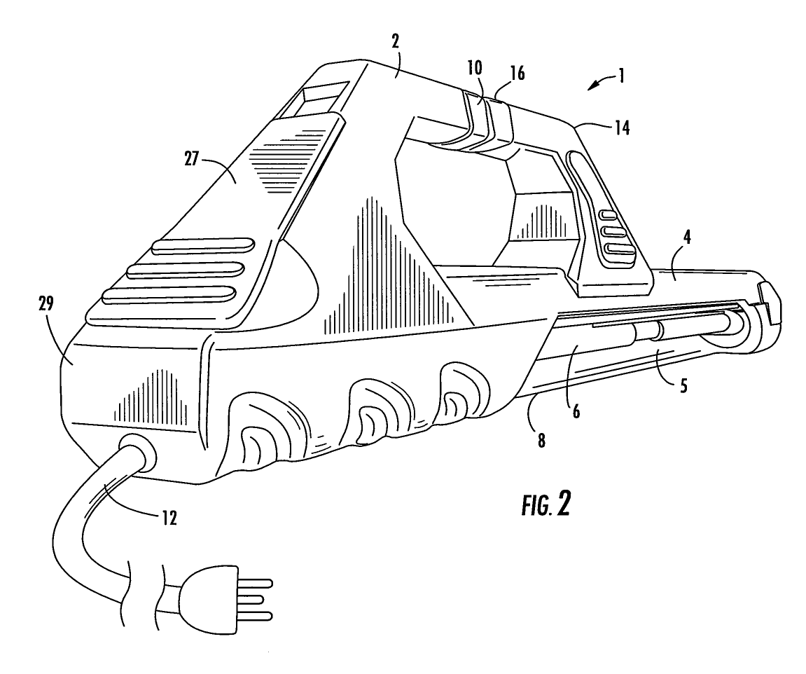

Referring to FIGS. 1 and 2 the light of the invention is shown generally at 1 and consists of an elongated body 4 that defines a cavity 5. A light source 6, such as a fluorescent tube, is supported in cavity 5. A transparent cover 8 encloses the light source 6 such that the light source is protected from the external environment. An electrical conductor or cord 12 provides electrical power to the light and terminates in a plug suitable for connection to an electrical power outlet. While the clamp light 1 is shown as powered from an external power source, an internal power source such as a battery may be used. A fixed jaw 2 is supported adjacent one end of the elongated body 4 in a fixed position relative to the body. Fixed jaw 2 supports a jaw pad 10 made of a compressible elastomeric material. A movable jaw 14 is supported on the body 4 such that it can slide along the length of the body towards and away from the fixed jaw 2. In one embodiment the movable jaw moves in a linear path. The movable jaw 14 includes a compressible jaw pad 16 similar to jaw pad 10 and is arranged such that the jaw pads 10 and 16 are opposed to and facing one another. Movable jaw 14 may be moved toward fixed jaw 2 to clamp a support structure between jaw pads 10 and 16. The jaw pads 10 and 16 contact the support structure to which the light is secured and the compressible material of the jaw pads apply a compression force on the support structure. A ratcheting locking mechanism for locking the movable jaw 14 in the desired position is provided as will hereinafter be described.

Referring to FIG. 3, in the illustrated embodiment the elongated body 4 is divided along its longitudinal axis into two substantially identical body portions 20 and 22 although other assemblies of the body may be used. The elongated body 4 may be of any length provided that it is long enough to allow the movable jaw 14 to move toward and away from the fixed jaw 2 to span a desired range of support structures and effectuate the clamping action. In one embodiment the body 4 is approximately 21 inches long although the length of the body may vary depending on the use of the light. The body 4 is dimensioned such that it has a wand-type structure where the length of the body may be approximately 8 to 10 times larger than its width or height. The body 4 is designed to generally conform to the size and shape of a long light source such as a fluorescent tube while enclosing and protecting the tube.

Located between the body portions 20 and 22 is a grommet 24 that receives the cord 12 and allows the cord to pass through the body 4 but forms a water tight seal that prevents moisture or debris from entering the interior of the body. A ballast 28 may also be carried in body 4 for powering a fluorescent tube as is known. A rocker switch 32 is also supported between the body portions 20 and 22 and is operatively connected to the power source to control the powering of light source 6.

Located in the body 4 and positioned at opposite ends of cavity 5 are lamp holders 30 for securing the ends of the light source 6 and protecting the light source against damage due to vibration or impact. At least one of the lamp holders 30 comprises an electrical socket connected to the power source via cord 12 and rocker switch 32 for providing electrical power to the light source 6.

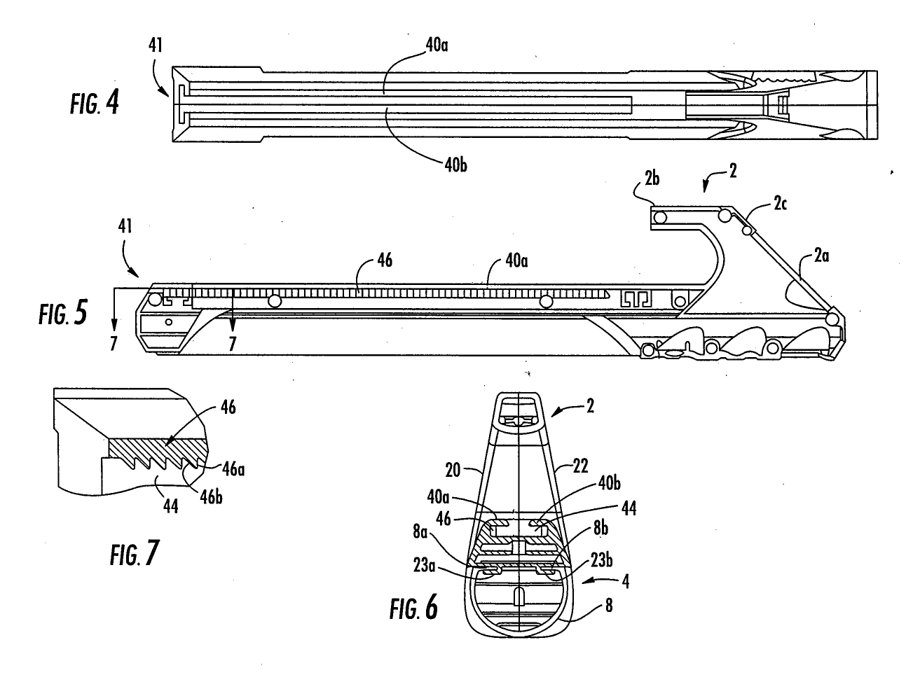

Transparent cover 8 has a generally U-shaped transverse cross section. Referring to FIG. 6, flanges 23a and 23b extend from the body portions 20 and 22 to create slots on the body 4 for receiving lips 8a and 8b formed on the edge of the cover 8 to retain the cover on the body. Referring to FIG. 3, an end cap 11 is fitted over the end of the body 4 to isolate the light source 6 from the external environment and retain the cover 8 on the body.

Referring to FIG. 3, the electrical conductors of cord 12 are also connected to an electric power outlet 26 to provide electrical power thereto. Outlet 26 is trapped between body portions 20 and 22 such that the outlet is exposed to the exterior of the body. Accessories may be plugged into outlet 26 such that the clamp light 1 of the invention may act as an extension cord in addition to functioning as a light. A rigid plate 27 formed with pivots 27a and 27b is pivotably connected to the body 4 to allow the plate to pivot relative to the body 4. Pivots 27a and 27b may be formed as pins that are rotatably received in receptacles 29 formed in body portions 20 and 22. Plate 27 can be pivoted away from the body 4 to expose the outlet 26 and can be pivoted toward the body 4 to cover the outlet 26 when not in use. Plate 27 can also be used as a stand to support the light in a vertical position on a substantially vertical surface. Specifically, plate 27 is pivoted away from the body a distance, shown in dashed lines in FIG. 1, such that the light can be stood vertically on end and be supported in a freestanding manner by the edge of plate 27 and the end surface 29 of the body 4. Plate 27 may be used without outlet 26 such that it functions only as a stand.

Jaw 2 has a base portion 2a, a clamp pad supporting portion 2b and a connecting portion 2c between the base portion 2a and the clamp pad supporting portion 4b. The natural resiliency of the plastic material and the relatively thin connecting portion 2c allows the jaw 2 to flex slightly when a clamping force is applied by the jaw to the support structure. The flexing of the jaw increases the clamping force applied by the jaw on the support structure.

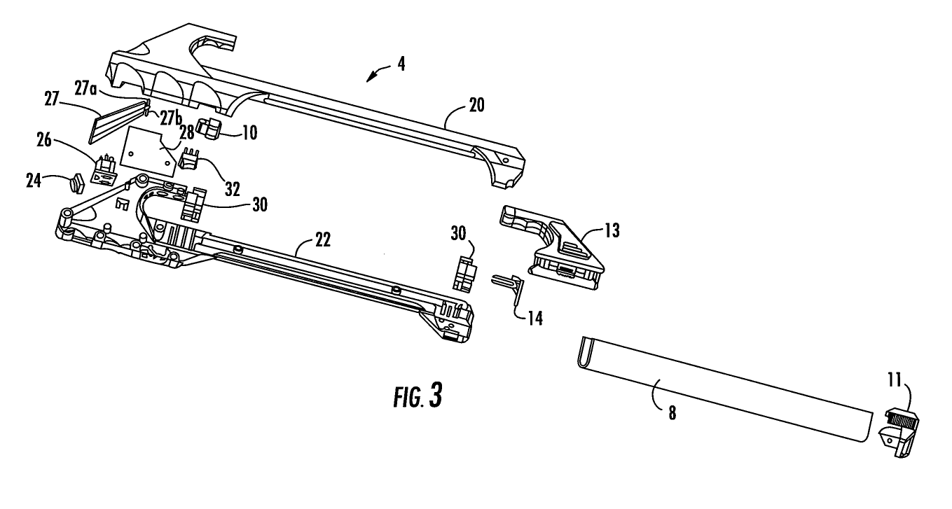

Referring to FIGS. 4, 5 and 6, the body portions 20 and 22 include flanges 40a and 40b that extend along the body 4 from the distal end 41 of the body to adjacent fixed jaw 2. Flanges 40a and 40b create a pair of rails on which the movable jaw 14 rides. Flanges 40a and 40b also define a generally T-shaped cavity 44. A plurality of ratchet teeth 46 are formed on one of the sidewalls of cavity 44 and extend for the length thereof. The ratchet teeth 46 comprise a first face 46a that is arranged substantially perpendicularly to the direction of travel of the movable jaw 14 and an opposing face 46b is arranged at about a 45 degree angle relative to the direction of travel of the movable jaw.

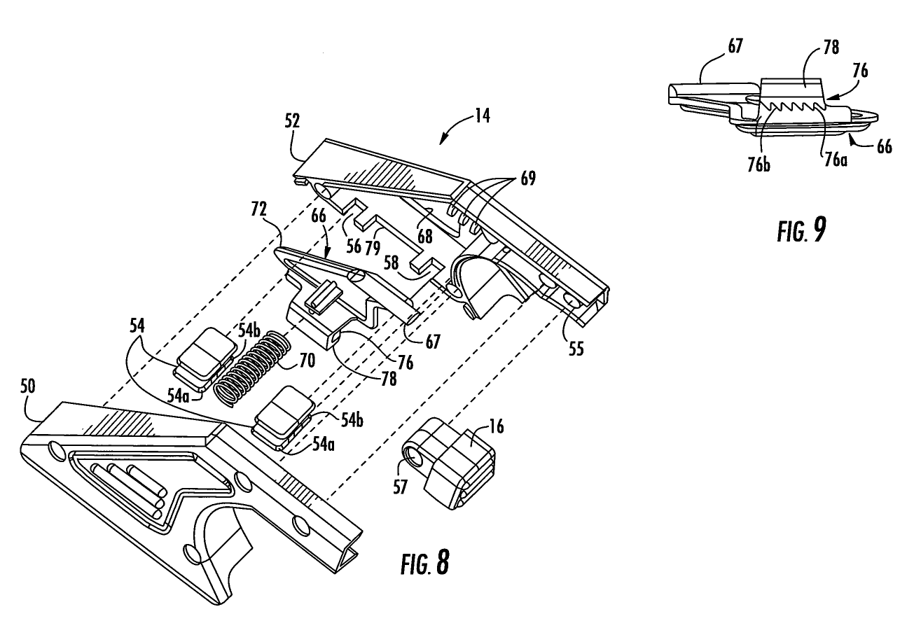

Referring to FIG. 8, the movable jaw 14 is shown comprising a first jaw portion 50 and a second jaw portion 52. The jaw portions 50 and 52 are secured to one another to create the movable jaw 14. Jaw pad 16 is trapped between the jaw portions 50 and 52 and may be retained therein by a pin 55 that engages aperture 57 a formed on the jaw pad 16. A pair of axially aligned clamp guides 54 are retained in recesses 56 and 58, respectively, formed in the jaw portions 50 and 52 such that the clamp guides 54 extend from the bottom of the movable jaw 14. The clamp guides 54 are arranged such that flanges 54a and 54b create generally T-shaped extensions that extend from the bottom of the movable jaw 14. The flanges 54a and 54b extend into T-shaped cavity 44 formed by flanges 40a and 40b on body 4. The engagement between the clamp guides 54 and the flanges 40a and 40b retains the movable jaw 14 on the body 4 while allowing the movable jaw to slide over the body 4 along substantially the length thereof. As best shown in FIG. 1, movable jaw 14 is formed with a base portion 14a, clamp pad supporting portion 14b and a connecting portion 14c such that it can flex slightly as previously described with respect to jaw 4.

The locking mechanism for the movable jaw 14 will now be described with reference to Fogs. 8 and 9. A clamp trigger 66 is pivotably connected to jaw portion 52 such that the clamp trigger can pivot toward and away from jaw portion 52. In the illustrated embodiment clamp trigger 66 is formed with a cylindrical hinge 67 that is rotatably supported by mating flanges 69 formed in jaw portion 52. Jaw portion 52 is formed with an aperture 68 that matches the general shape and size of clamp trigger 66 such that clamp trigger 66 can be accessed by the user as will hereinafter be described. A spring 70 is disposed between the jaw portion 50 and the clamp trigger 66 to bias the clamp trigger 66 toward jaw portion 52 (the extended or locked position). Clamp trigger 66 is formed with a peripheral flange 72 that contacts the inside surface of jaw portion 52 adjacent aperture 68 to maintain the clamp trigger substantially flush with the jaw portion 52 when in the extended position. A user can press the clamp trigger 66 to move the clamp trigger away from jaw portion 52 and towards jaw portion 50 (the retracted or unlocked position).

The clamp trigger includes a flange 78 that extends through aperture 79 and outside of and below the movable jaw 14. Flange 78 is formed with a series of ratchet teeth 76 that are arranged so as to extend into the cavity 44 formed in the body 4 and to matingly engage the ratchet teeth 46 when the clamp trigger 66 is in the extended position. The ratchet teeth 76 comprise a first face 76a that is arranged substantially perpendicularly to the direction of travel of the movable jaw and the opposing face 76b is arranged at about a 45 degree angle relative to the direction of travel of the movable jaw. The engagement of ratchet teeth 46 with ratchet teeth 76 allow the movable jaw 14 to move toward the fixed jaw 2 because the angled faces 46b and 76b are able to slide over one another even when clamp trigger is in the locked position. In the locked position the engagement of ratchet teeth 46 and 76 prevent the movable jaw 14 from moving away from the fixed jaw 2 because faces 46a and 76a abut one another. When the user depresses the clamp trigger 66 and overcomes the force of spring 70, the clamp trigger is pivoted to its retracted or unlocked position where teeth 76 are disengaged from teeth 46 such that the movable jaw 14 may be freely moved away from the fixed jaw 2. The movable jaw 14 may be slid completely off of body 4 such that jaw 2 can be used to hang the light from a structure by hooking fixed jaw 2 on the structure.

The operation of the light of the invention will now be described. To mount the light to a support structure, the movable jaw 14 is moved away from the fixed jaw 2 by applying a force to the clamp trigger 66 sufficient to overcome the force of spring 70 and disengage the ratchet teeth 46 from ratchet teeth 76. While depressing the clamp trigger 66, the user can then slide the movable jaw 14 away from the fixed jaw 2 to make the space between the jaws larger than the dimension of the support structure on which the clamp light 1 is to be mounted. The support structure may be any fixture located at the work site including, for example, a work bench, ceiling joists, studs, other equipment or any relatively immovable object. The location of the clamp trigger 66 on the movable jaw 14 allows the locking mechanism to be unlocked and the movable jaw 14 to be moved over the elongated body 4 with one hand.

Once the jaws are spaced a sufficient distance to receive the support structure, the clamp trigger 66 is released and is biased by spring 70 to the locked position. Eventhough the locking mechanism is in the locked position and the ratchet teeth 46 and 76 are engaged, the ratchet teeth allow the movable jaw 14 to be moved toward the fixed jaw 2 without the need to depress the clamp trigger 66. The support structure is positioned between the jaws and the movable jaw 14 is moved toward the fixed jaw 2 until a sufficient clamping force is developed to hold the clamp light 1 on the support structure. The clamping force is in part generated by the resiliency of the clamping pads 10 and 16. When the jaws are closed on a support structure a sufficient force is applied by the user to compress the clamp pads 10 and 16 slightly. The engagement of ratchet teeth 46 and 76 prevent the jaws from separating such that the pads remain under a compressive load that creates a force on the support structure sufficient to maintain the light in the desired position on the support structure. Further gripping force may be created by the resiliency of jaws 14 and 2 such that the jaws as well as the pads create a compressive clamping force on the support structure. Specifically, the jaws may be deformed slightly when the support structure is clamped such that the jaws provide additional clamping force.

The clamp light of the invention can be mounted on a wide variety of different shapes and sizes of support structures because the jaws are able to span substantially the entire length of the light body. The use of the ratcheting locking mechanism is also simple and easy to use. The construction of the light is rugged and relatively simple to manufacture.

Specific embodiments of an invention are disclosed herein. One of ordinary skill in the art will recognize that the invention has other applications in other environments. Many embodiments are possible. The following claims are in no way intended to limit the scope of the invention to the specific embodiments described above

1. A light comprising:
an elongated body;
a fixed jaw supported by the body;
a movable jaw slidably supported on the body and movable toward and away from the fixed jaw; and
a light source supported by the body.

2. The light of claim 1 wherein the movable jaw can slide relative to the body from a first position adjacent the fixed jaw to a second position proximate an end of the body remote from the fixed jaw.

3. The light of claim 1 wherein the fixed jaw is located at one end of the elongated body.

4. The light of claim 1 further including a locking mechanism for locking the movable jaw relative to the elongated body.

5. The light of claim 4 wherein the locking mechanism prevents movement of the movable jaw in a first direction but allows movement of the movable jaw in a second direction.

6. The light of claim 5 wherein the first direction is away from the fixed jaw.

7. The light of claim 4 wherein the locking mechanism includes a ratchet.

8. The light of claim 7 wherein the ratchet includes a first set of ratchet teeth on the movable jaw and a second set of ratchet teeth on the elongated body.

9. The light of claim 8 wherein the first set of ratchet teeth is biased into engagement with the second set of ratchet teeth.

10. The light of claim 8 wherein the second set of ratchet teeth extend from substantially adjacent to the fixed jaw to substantially an end of the elongated body remote from the fixed jaw.

11. The light of claim 1 wherein one of the fixed jaw or movable jaw includes a resilient clamp pad.

12. The light of claim 1 wherein the fixed jaw and movable jaw include resilient clamp pads.

13. The light of claim 1 wherein one of the fixed or movable jaws is resilient.

14. The light of claim 1 further including a power outlet.

15. The light of claim 14 further including a movable cover covering the outlet.

16. The light of claim 15 wherein the cover is movable to a first position where it supports the light in a free standing manner.

17. The light of claim 1 wherein the light source is a fluorescent tube.

18. The light of claim 1 further including a member movable to a first position where it supports the light in a free standing manner.

19. The light of claim 1 wherein the light is supported in the freestanding manner using the member and a portion of the body.
